(19) United States
(12) Patent Application Publication
(10) Pub. No.: US 2024/0170736 A1
(43) Pub. Date: May 23, 2024

(54) FLAME RETARDANTS FOR BATTERY ELECTROLYTES

(71) Applicant: Albemarle Corporation, Charlotte, NC (US)

(72) Inventor: Charles Daniel Varnado, JR., Baton Rouge, LA (US)

(21) Appl. No.: 18/284,007

(22) PCT Filed: Mar. 31, 2022
(86) PCT No.: PCT/US2022/022735

§ 371 Date: Sep. 25, 2023

Related U.S. Application Data
(60) Provisional application No. 63/169,433, filed on Apr. 1, 2021.

(51) Int. Cl. H01M 10/42; H01M 10/052; H01M 10/0567; H01M 10/0569

(52) U.S. Cl. CPC H01M 10/4235; H01M 10/052; H01M 10/0567; H01M 10/0569

(57) ABSTRACT

This invention provides nonaqueous electrolyte solutions for lithium batteries. The nonaqueous electrolyte solutions comprise a liquid electrolyte medium; a lithium-containing salt; and at least one oxygen-containing brominated flame retardant.

### TECHNICAL FIELD

This invention relates to brominated flame retardants for electrolyte solutions for batteries.

### BACKGROUND

One of the components impacting the safety of lithium-ion batteries is their use of flammable solvents in the lithium-containing electrolyte solutions. Inclusion of a flame retardant in the electrolyte solution is one way to mitigate the flammability of these solutions. For a flame retardant to be a suitable component of an electrolyte solution, solubility in the electrolyte is needed, along with electrochemical stability over the range of battery operation, and minimal negative effect on battery performance. Negative effects on battery performance can include reduced conductivity chemical instability to the active material, consumption of lithium, and/or formation of resistive interfaces on the active materials, which can have a deleterious impact on solid electrolyte interface (SEI) formation during initial cycling, resulting in chemical degradation of the electrolyte.

What is desired is a flame retardant that can effectively suppress the flammability of lithium ion batteries with minimal impact to the electrochemical performance of the lithium ion battery at a reasonable cost.

### SUMMARY OF THE INVENTION

This invention provides nonaqueous electrolyte solutions for lithium batteries which contain at least one oxygen-containing brominated flame retardant. In the presence of the oxygen-containing brominated flame retardant(s), fires are extinguished in these nonaqueous electrolyte solutions, at least under laboratory conditions.

An embodiment of this invention is a nonaqueous electrolyte solution for a lithium battery, which solution comprises i) a liquid electrolyte medium; ii) a lithium-containing salt; and iii) at least one oxygen-containing brominated flame retardant. The oxygen-containing brominated flame retardant is selected from A) a brominated benzene comprising one phenyl ring having two or three bromine atoms bound to the phenyl ring and at least one oxygen-containing group bound to the phenyl ring via an oxygen atom, any remaining sites on the phenyl ring each being bound to a hydrogen atom, with the proviso that and when there is only one oxygen-containing group, the oxygen-containing group is an alkoxyether group, and B) a brominated fluorobenzene comprising one phenyl ring having at least one bromine atom bound to the phenyl ring, at least one fluorine atom bound to the phenyl ring, and an oxygen-containing group bound to the phenyl ring via an oxygen atom, wherein the oxygen-containing group is an alkoxyether group or an alkoxy group.

Another embodiment of this invention is a nonaqueous electrolyte solution for a lithium battery, which solution comprises i) a liquid electrolyte medium; ii) a lithium-containing salt; and iii) at least one oxygen-containing brominated flame retardant. The oxygen-containing brominated flame retardant is selected from the group consisting of 2,6-dimethoxy-1-(1,4,7,10-tetraoxaundecyl)-3,4,5-tribromobenzene, 4,5,6-tribromo-1,2,3-tri(2-methoxyethoxy)benzene, 2,4-dibromo-5-methoxy-1-(1,4,7,10-tetraoxaundecyl)benzene, 2,4-dibromo-5-ethoxy-1-(1,4,7,10-tetraoxaundecyl)benzene, 2,5-dibromo-4-methoxy-1-(1,4,7,10-tetraoxaundecyl)-benzene, 2,5-dibromo-4-ethoxy-1-(1,4,7,10-tetraoxaundecyl)benzene, 4,5-dibromo-2-ethoxy-1-(1,4,7,10-tetraoxaundecyl)benzene, 3,4,5-tribromo-1-ethoxy-2-(1,4,7,10-tetraoxaundecyl)-benzene, 2,4-dibromo-5-methoxy-1-[(2-ethoxy)ethoxy]benzene, 2,4-dibromo-5-ethoxy-1-[(2-ethoxy)ethoxy]benzene, 2,4-dibromo-1-[(2-ethoxy)ethoxy]benzene, 2,6-dibromo-1-[(2-ethoxy)ethoxy]benzene, 2,6-dibromo-4-fluoro-1-[(2-methoxy)ethoxy]benzene, 2,6-dibromo-4-fluoro-1-methoxybenzene (2,6-dibromo-4-fluoroanisole), 2,6-dibromo-4-fluoro-1-ethoxybenzene, 4-fluoro-2-bromo-1-methoxybenzene (4-fluoro-2-bromoanisole), and 4-fluoro-2-bromo-1-methoxybenzene.

These and other embodiments and features of this invention will be still further apparent from the ensuing description and appended claims.

### FURTHER DETAILED DESCRIPTION OF THE INVENTION

Throughout this document, the phrase “electrolyte solution” is used interchangeably with the phrase “nonaqueous electrolyte solution”.

The liquid electrolyte medium is comprised of one or more solvents that typically form the liquid electrolyte medium for lithium electrolyte solutions used in lithium batteries, which solvents are polar and aprotic, stable to electrochemical cycling, and preferably have low viscosity. These solvents usually include noncyclic carbonic acid esters, cyclic carbonic acid esters, ethers, sulfur-containing compounds, and esters of boric acid.

The solvents that can form the liquid electrolyte medium in the practice of this invention include ethylene carbonate (1,3-dioxolan-2-one), dim ethyl carbonate, ethyl methyl carbonate, diethyl carbonate, dioxolane, dimethoxy ethane (glyme), tetrahydrofuran, ethylene sulfite, 1,3-propylene glycol boric ester, bis(2,2,2-trifluoroethyl)ether, and mixtures of any two or more of the foregoing.

Preferred solvents include ethylene carbonate, ethyl methyl carbonate, and mixtures thereof. More preferred are mixtures of ethylene carbonate and ethyl methyl carbonate, especially at volume ratios of ethylene carbonate:ethyl methyl carbonate ratios of about 20:80 to about 40:60, more preferably about 25:75 to about 35:65.

Suitable lithium-containing salts in the practice of this invention include lithium perchlorate, lithium nitrate, lithium thiocyanate, lithium aluminate, lithium tetrachloroaluminate, lithium tetrafluoroaluminate, lithium tetraphenylborate, lithium tetrafluoroborate, lithium bi s (oxol ato)b orate (LiBOB), lithium di(fluoro)(oxalato)borate, lithium hexafluorophosphate, lithium hexafluoroarsenate, lithium hexafluoroantimonate, lithium titanium oxide, lithium manganese oxide, lithium cobalt oxide (LiCoO₂), lithium nickel oxide (LiNiO₂), lithium alkyl carbonates in which the alkyl group has 1 to 6 carbon atoms, lithium methylsulfonate, lithium trifluoromethylsulfonate, lithium pentafluoroethylsulfonate, lithium pentafluorophenylsulfonate, lithium fluorosulfonate, lithium bis(trifluoromethyl sulfonyl)imide, lithium bis(pentafluoroethyl sulfonyl)imide, lithium (ethylsulfonyl)(trifluoromethylsulfonyl)imide, and mixtures of any two or more of the foregoing. Preferred lithium-containing salts include lithium hexafluorophosphate, lithium tetrafluoroborate, lithium di(fluoro)(oxolato)borate, and lithium bis(oxolato)borate.

Typical concentrations for the lithium-containing salt in the electrolyte solution are in the range of about 0.1 M to about 2.5 M, preferably about 0.5 M to about 2 M, more preferably about 0.75 M to about 1.75 M, and still more preferably about 0.95 M to about 1.5 M. When more than one lithium-containing salt forms the lithium-containing electrolyte, the concentration refers to the total concentration of all of the lithium-containing salts present in the electrolyte solution.

The electrolyte solution can contain other salts in addition to lithium salts, unless such other salt(s) materially degrade either the performance of the battery for the desired application, or the flame retardancy of the electrolyte solution. Suitable electrolytes other than lithium salts include other alkali metal salts, e.g., sodium salts, potassium salts, rubidium salts, and cesium salts, and alkaline earth metal salts, e.g., magnesium salts, calcium salts, strontium salts, and barium salts. In some aspects, the salts in the non-aqueous electrolyte solution are only one or more lithium salts.

Suitable alkali metal salts that can be present in the electrolyte solution include sodium salts such as sodium chloride, sodium bromide, sodium iodide, sodium perchlorate, sodium nitrate, sodium thiocyanate, sodium aluminate, sodium tetrachloroaluminate, sodium tetrafluoroaluminate, sodium tetraphenylborate, sodium tetrafluoroborate, and sodium hexafluorophosphate; and potassium salts such as potassium chloride, potassium bromide, potassium iodide, potassium perchlorate, potassium nitrate, potassium thiocyanate, potassium aluminate, potassium tetrachloroaluminate, potassium tetrafluoroaluminate, potassium tetraphenylborate, potassium tetrafluoroborate, and potassium hexafluorophosphate.

Suitable alkaline earth metal salts that can be present in the electrolyte solution include magnesium salts such as magnesium chloride, magnesium bromide, magnesium iodide, magnesium perchlorate, magnesium nitrate, magnesium thiocyanate, magnesium aluminate, magnesium tetrachloroaluminate, magnesium tetrafluoroaluminate, magnesium tetraphenylborate, magnesium tetrafluoroborate, and magnesium hexafluorophosphate; and calcium salts such as calcium chloride, calcium bromide, calcium iodide, calcium perchlorate, calcium nitrate, calcium thiocyanate, calcium aluminate, calcium tetrachloroaluminate, calcium tetrafluoroaluminate, calcium tetraphenylborate, calcium tetrafluoroborate, and calcium hexafluorophosphate.

In the practice of this invention, liquid brominated flame retardants are miscible with the liquid medium of the nonaqueous electrolyte solution, where “miscible” means that the brominated flame retardant does not form a separate phase from the electrolyte solution. More specifically, a brominated flame retardant is miscible if it forms a single phase in a mixture of 30 wt % ethylene carbonate and 70 wt % ethyl methyl carbonate which contains 1.2 M lithium hexafluorophosphate, after stirring overnight with a magnetic stirrer to dissolve solid compounds, and no separate phase is formed after the stirring is stopped, and the brominated flame retardant does not precipitate from, or form a suspension or slurry in, the nonaqueous electrolyte solution. It is recommended and preferred that the brominated flame retardant does not cause the precipitation of, or formation of a suspension or slurry of, any of the other components of the nonaqueous electrolyte solution.

In the practice of this invention, solid brominated flame retardants are soluble in the liquid medium of the nonaqueous electrolyte solution, where “soluble” means that the brominated flame retardant does not precipitate from the electrolyte solution. More specifically, a brominated flame retardant is soluble if it forms a single phase in a mixture of 30 wt % ethylene carbonate and 70 wt % ethyl methyl carbonate which contains 1.2 M lithium hexafluorophosphate, after stirring overnight with a magnetic stirrer to dissolve solid compounds, and no separate phase or precipitate is formed after the stirring is stopped, and the brominated flame retardant does not precipitate from, or form a suspension or slurry in, the nonaqueous electrolyte solution. It is recommended and preferred that the brominated flame retardant does not cause the precipitation of, or formation of a suspension or slurry of, any of the other components of the nonaqueous electrolyte solution.

In the practice of this invention, the oxygen-containing brominated flame retardants generally have a bromine content of about 30 wt % or more, preferably about 35 wt % or more, based on the weight of the oxygen-containing brominated flame retardant. The oxygen-containing brominated flame retardants in the practice of this invention have a bromine content in the molecule that ranges from about 30 wt % to about 70 wt %, more preferably about 35 wt % to about 65 wt %.

The boiling point of the brominated flame retardants in this invention are about 75° C. or more, preferably about 95° C. or more. Generally, the brominated flame retardants used in the practice of this invention have boiling points near or above the boiling point of the solvent or solvent mixture of the nonaqueous electrolyte solution. The boiling points described throughout this document are at standard temperature and pressure (standard conditions) unless otherwise stated.

The brominated flame retardants used in the practice of this invention are generally polar and aprotic, and stable to electrochemical cycling. Liquid brominated flame retardants preferably also have low viscosities and/or do not significantly increase the viscosity of the nonaqueous electrolyte solution.

The oxygen-containing brominated flame retardants of this invention share some overall characteristics. In these brominated flame retardants, the bromine content is about 30 wt % or more, preferably about 30 wt % to about 70 wt %, more preferably about 35 wt % to about 65 wt %, relative to the total weight of the brominated flame retardant molecule.

In the practice of this invention, a flame retardant amount in the nonaqueous electrolyte solution means enough flame retardant is present that the solution passes the modified horizontal UL-94 test described below. The flame retardant amount is often different for different brominated flame retardants. For the brominated benzenes, the flame retardant amount is usually about 12.5 wt % bromine or more, sometimes 13 wt % bromine or more, relative to the total weight of the nonaqueous electrolyte solution. For the brominated fluorobenzenes, the flame retardant amount is usually about 11.5 wt % bromine or more, sometimes 12 wt % bromine or more, relative to the total weight of the nonaqueous electrolyte solution. To have a flame retardant amount in solution, the brominated flame retardants of this invention are typically present in amounts of about 20 wt % or more flame retardant molecules, often 25 wt % or more flame retardant molecules, relative to the total weight of the nonaqueous electrolyte solution.

In some embodiments, the oxygen-containing brominated flame retardant is a brominated benzene. The brominated benzene comprises one phenyl ring having two or three bromine atoms bound to the phenyl ring and at least one oxygen-containing group bound to the phenyl ring via an oxygen atom. The brominated benzenes have a bromine content of about 30 wt % or more, preferably about 30 wt % to about 70 wt %, more preferably about 35 wt % to about 65 wt %, still more preferably about 35 wt % to about 60 wt %, based on the weight of the brominated flame retardant.

In some preferred embodiments, the brominated benzenes have about eight to about twenty carbon atoms, preferably eight to about sixteen carbon atoms, in the molecule. Preferably, the brominated benzenes have two to about ten oxygen atoms, more preferably two to about eight oxygen atoms, in the molecule.

When there is only one oxygen-containing group in the brominated benzene molecule, the group is an alkoxyether group. In the alkoxyether groups, the hydrocarbyl portions of the groups are saturated. The alkoxyether groups have two to about ten carbon atoms, preferably three to about eight carbon atoms. The alkoxyether groups have two to about six oxygen atoms, preferably two to about five oxygen atoms. More preferably, the alkoxyether group containing two or more oxygen atoms has an ethylene unit between each pair of oxygen atoms, and the terminal group is preferably methyl or ethyl. Preferred alkoxyether groups include 2-methoxyethoxy, 2-ethoxyethoxy, and 1,4,7,10-tetraoxaundecyl.

In some preferred embodiments, when there is more than one oxygen-containing group on the phenyl ring of the brominated benzene, one of the oxygen-containing groups is a hydrocarbyloxy group. More preferably, the hydrocarbyloxy group is an alkoxy group having one to about four carbon atoms, preferably one or two carbon atoms. Preferred hydrocarbyloxy groups include methoxy and ethoxy.

In other preferred embodiments, when there are two oxygen-containing groups on the phenyl ring of the brominated benzenes, one of the oxygen-containing groups is an alkoxyether group and the other oxygen-containing group is a hydrocarbyloxy group; preferences for the alkoxyether group and hydrocarbyloxy group are as described above. More preferably, there are two bromine atoms on the phenyl ring.

In still other preferred embodiments, when there are three bromine atoms on the phenyl ring, there are at least two and preferably three oxygen-containing groups on the phenyl ring of the brominated benzenes, and one of the oxygen-containing groups is an alkoxyether group and the other one or two oxygen-containing groups is each a hydrocarbyloxy group; preferences for alkoxyether groups and hydrocarbyloxy groups are as described above.

In still other preferred embodiments, when there are two bromine atoms on the phenyl ring, the bromine atoms are preferably ortho or para relative to each other; more preferably, there are one or two oxygen-containing groups on the phenyl ring of the brominated benzenes.

In still other preferred embodiments, when there are three bromine atoms on the phenyl ring, there are preferably three oxygen-containing groups on the phenyl ring of the brominated benzenes, and all three of the oxygen-containing groups are alkoxyether groups; preferences for alkoxyether groups are as described above.

When there is only one oxygen-containing group in the brominated benzene molecule, at least one bromine atom is preferably adjacent (ortho) to the group containing two or more oxygen atoms; in some preferred embodiments, two bromine atoms are adjacent to the alkoxyether group. In other preferred embodiments in which there is only one oxygen-containing group in the brominated benzene molecule, there are one or more fluorine atoms, preferably one fluorine atom, bound to the phenyl ring.

Preferably, the brominated benzene is 2,6-dimethoxy-1-(1,4,7,10-tetraoxaundecyl)-3,4,5-tribromobenzene, 4,5,6-tribromo-1,2,3-tri(2-methoxyethoxy)benzene, 2,4-dibromo-5-methoxy-1-(1,4,7,10-tetraoxaundecyl)benzene, 2,4-dibromo-5-methoxy-1-(1,4,7,10-tetraoxaundecyl)benzene, 2,4-dibromo-5-ethoxy-1-(1,4,7,10-tetraoxaundecyl)benzene, 2,5-dibromo-4-methoxy-1-(1,4,7,10-tetraoxaundecyl)benzene, 2,5-dibromo-4-ethoxy-1-(1,4,7,10-tetraoxaundecyl)benzene, 4,5-dibromo-2-ethoxy-1-(1,4,7,10-tetraoxaundecyl)benzene, 3,4,5-tribromo-1-ethoxy-2-(1,4,7,10-tetraoxaundecyl)-benzene, 2,4-dibromo-5-methoxy-1-[(2-ethoxy)ethoxy]benzene, 2,4-dibromo-5-ethoxy-1-[(2-ethoxy)ethoxy]benzene, 2,4-dibromo-1-[(2-ethoxy)ethoxy]benzene, 2,6-dibromo-1-[(2-ethoxy)ethoxy]benzene, or 2,6-dibromo-4-fluoro-1-[(2-methoxy)ethoxy]benzene. More preferably, the brominated benzene is 2,5-dibromo-4-methoxy-1-(1,4,7,10-tetraoxaundecyl)benzene, 2,5-dibromo-4-ethoxy-1-(1,4,7,10-tetraoxaundecyl)benzene, or 4,5-dibromo-2-ethoxy-1-(1,4,7,10-tetraoxaundecyl)benzene.

In another embodiment, the oxygen-containing brominated flame retardant is a brominated fluorobenzene. The brominated fluorobenzene comprises one phenyl ring having one or more bromine atoms bound to the phenyl ring, one or more fluorine atoms bound to the phenyl ring, and an oxygen-containing group bound to the phenyl ring via an oxygen atom. The brominated fluorobenzenes have a bromine content of about 35 wt % or more, preferably about 35 wt % to about 65 wt %, more preferably about 40 wt % to about 60 wt %, based on the weight of the brominated flame retardant.

In some preferred embodiments, the brominated fluorobenzenes have one bromine atom or two bromine atoms bound to the phenyl ring and/or one fluorine atom bound to the phenyl ring. More preferably, when there is only one fluorine atom bound to the phenyl ring, it is para relative to the oxygen-containing group. Preferred positions on the ring for the bromine atoms are those adjacent (ortho) to the oxygen-containing group; preferably, at least one bromine atom is adjacent to the oxygen-containing group.

In some preferred embodiments, the brominated fluorobenzenes have seven to about fifteen carbon atoms, preferably seven to about thirteen carbon atoms, in the molecule. Preferably, the brominated benzenes have one to about four oxygen atoms, more preferably one to about two oxygen atoms, in the molecule.

The oxygen-containing group in the brominated fluorobenzene is an alkoxy group or an alkoxyether group. Preferably, the alkoxy group has one to about four carbon atoms, more preferably one or two carbon atoms. Preferred alkoxy groups include methoxy and ethoxy. In the alkoxyether groups, the hydrocarbyl portions of the groups are saturated. The alkoxyether groups have two to about ten carbon atoms, preferably three to about eight carbon atoms. The alkoxyether groups have two to about six oxygen atoms, preferably two to about five oxygen atoms. More preferably, the alkoxyether group containing two or more oxygen atoms has an ethylene unit between each pair of oxygen atoms, and the terminal group is preferably methyl or ethyl. Preferred alkoxyether groups include 2-methoxyethoxy, 2-ethoxyethoxy, and 1,4,7,10-tetraoxaundecyl.

Preferably, the brominated fluorobenzene is 2,6-dibromo-4-fluoro-1-methoxybenzene, 2,6-dibromo-4-fluoro-1-ethoxybenzene, 4-fluoro-2-bromo-1-methoxybenzene, or 4-fluoro-2-bromo-1-methoxybenzene.

In some preferred embodiments of the invention, the liquid electrolyte medium is ethylene carbonate, ethyl methyl carbonate, or a mixture thereof. More preferably, the lithium-containing salt is lithium hexafluorophosphate, lithium di(fluoro)(oxalato)borate, or lithium bis(oxalato)borate.

In some embodiments of the invention, at least one electrochemical additive is included in the nonaqueous electrolyte solution.

In the practice of this invention, the electrochemical additives are soluble in, or miscible with, the liquid medium of the nonaqueous electrolyte solution. Electrochemical additives that are in liquid form are miscible with the liquid medium of the nonaqueous electrolyte solution, where “miscible” means that the electrochemical additives do not form a separate phase from the electrolyte solution. More specifically, an electrochemical additive is miscible if it forms a single phase in a mixture of 30 wt % ethylene carbonate and 70 wt % ethyl methyl carbonate which contains 1.2 M lithium hexafluorophosphate, after stirring overnight with a magnetic stirrer to dissolve solid compounds, and no separate phase is formed after the stirring is stopped, and the electrochemical additive does not precipitate from, or form a suspension or slurry in, the nonaqueous electrolyte solution.

The term “soluble,” usually used for electrochemical additives in solid form, indicates that, once dissolved, the electrochemical additive does not precipitate from, or form a suspension or slurry in, the nonaqueous electrolyte solution. More specifically, an electrochemical additive is soluble if it dissolves in a mixture of 30 wt % ethylene carbonate and 70 wt % ethyl methyl carbonate which contains 1.2 M lithium hexafluorophosphate, after stirring overnight with a magnetic stirrer to dissolve solid compounds, and no separate phase is formed after the stirring is stopped. It is recommended and preferred that the electrochemical additive does not cause the precipitation of, or formation of a suspension or slurry of, any of the other components of the nonaqueous electrolyte solution.

The brominated flame retardant, electrochemical additive, and mixtures thereof are generally stable to electrochemical cycling, and preferably have low viscosities and/or do not significantly increase the viscosity of the nonaqueous electrolyte solution.

In various embodiments, the electrochemical additive is selected from a) unsaturated cyclic carbonates containing three to about four carbon atoms, b) fluorine-containing saturated cyclic carbonates containing three to about four carbon atoms and one to about two fluorine atoms, c) tris(trihydrocarbylsilyl) phosphites containing three to about six carbon atoms, d) trihydrocarbyl phosphates containing three to about nine carbon atoms, e) cyclic sultones containing three to about four carbon atoms, f) saturated cyclic hydrocarbyl sulfites having a 5-membered ring and containing two to about four carbon atoms, g) saturated cyclic hydrocarbyl sulfates having a 5-membered ring and containing two to about four carbon atoms, h) cyclic dioxadithio polyoxide compounds having a 6-membered or 7-membered ring and containing two to about four carbon atoms, i) another lithium-containing salt, and j) mixtures of any two or more of the foregoing.

In some embodiments, the electrochemical additive is an unsaturated cyclic carbonate containing three to about six carbon atoms, preferably three to about four carbon atoms. Suitable unsaturated cyclic carbonates include vinylene carbonate (1,3-dioxol-2-one), 4-methyl-1,3-dioxol-2-one, and 4,5-dimethyl-1,3-dioxol-2-one; vinylene carbonate is a preferred unsaturated cyclic carbonate. The unsaturated cyclic carbonate is preferably in an amount of about 0.5 wt % to about 12 wt %, more preferably about 0.5 wt % to about 3 wt % or about 8 wt % to about 11 wt %, relative to the total weight of the nonaqueous electrolyte solution.

When the electrochemical additive is a fluorine-containing saturated cyclic carbonate containing three to about five carbon atoms, preferably three to about four carbon atoms, and one to about four fluorine atoms, preferably one to about two fluorine atoms, suitable fluorine-containing saturated cyclic carbonates include 4-fluoro-ethylene carbonate and 4,5-difluoro-ethylene carbonate. Preferably the fluorine-containing saturated cyclic carbonate is 4-fluoro-ethylene carbonate. The fluorine-containing saturated cyclic carbonate is preferably in an amount of about 0.5 wt % to about 8 wt %, more preferably about 1.5 wt % to about 5 wt %, relative to the total weight of the nonaqueous electrolyte solution.

The tris(trihydrocarbylsilyl) phosphite electrochemical additives contain three to about nine carbon atoms, preferably about three to about six carbon atoms; the trihydrocarbylsilyl groups may be the same or different. Suitable tris(trihydrocarbylsilyl) phosphites include tris(trimethylsilyl) phosphite, bis(trimethylsilyl)(triethylsilyl) phosphite, tris(triethylsilyl) phosphite, bis(trimethylsilyl)(triethylsilyl) phosphite, bis(trimethylsilyl)(tri-n-propylsilyl)phosphite, and tris(tri-n-propylsilyl) phosphite; tris(trimethylsilyl) phosphite is a preferred tris(trihydrocarbylsilyl) phosphite. The tris(trihydrocarbylsilyl) phosphite is preferably in an amount of about 0.1 wt % to about 5 wt %, more preferably about 0.15 wt % to about 4 wt %, even more preferably about 0.2 wt % to about 3 wt %, relative to the total weight of the nonaqueous electrolyte solution.

In some embodiments, the electrochemical additive is a trihydrocarbyl phosphate containing three to about twelve carbon atoms, preferably three to about nine carbon atoms. The hydrocarbyl groups can be saturated or unsaturated, and the hydrocarbyl groups in the trihydrocarbyl phosphate may be the same or different. Suitable trihydrocarbyl phosphates include trimethyl phosphate, triethyl phosphate, dimethyl ethyl phosphate, tri-n-propyl phosphate, triallyl phosphate, and trivinyl phosphate; triallyl phosphate is a preferred trihydrocarbyl phosphate. The trihydrocarbyl phosphate is usually in an amount of about 0.5 wt % to about 5 wt %, preferably about 1 wt % to about 5 wt %, more preferably about 2 wt % to about 4 wt %, relative to the total weight of the nonaqueous electrolyte solution.

When the electrochemical additive is a cyclic sultone containing three to about eight carbon atoms, preferably three to about four carbon atoms, suitable cyclic sultones include 1-propane-1,3-sultone (1,3-propane sultone), 1-propene-1,2-sultone (1,3-propene sultone), 1,3-butane sultone (5-methyl-1,2-oxathiolane 2,2-dioxide), 2,4-butane sultone (3-methyl-1,2-oxathiolane 2,2-dioxide), 1,4-butane sultone (1,2-oxathiane 2,2-dioxide), 2-hydroxy-alpha-toluenesulfonic acid sultone (3H-1,2-benzoxathiole 2,2-dioxide), and 1,8-naphthosultone; preferred cyclic sultones include 1-propane-1,3-sultone and 1-propene-1,3-sultone. The cyclic sultone is preferably in an amount of about 0.25 wt % to about 5 wt %, more preferably about 0.5 wt % to about 4 wt %, relative to the total weight of the nonaqueous electrolyte solution.

The saturated cyclic hydrocarbyl sulfite electrochemical additive contains two to about six carbon atoms, preferably two to about four carbon atoms, and has a 5-membered or 6-membered ring, preferably a 5-membered ring. One or more substituents can be present on the ring, such as methyl or ethyl groups, preferably one or more methyl groups, more preferably, no substituents are present on the ring. Suitable saturated cyclic hydrocarbyl sulfites include 1,3,2-dioxathiolane, 2-oxide (1,2-ethylene sulfite), 1,2-propanediol sulfite (1,2-propylene sulfite), 4,5-dimethyl-1,3,2-dioxathiolane 2-oxide, 1,3,2-dioxathiane 2-oxide, 4-methyl-1,3-dioxathiane, 2-oxide (1,3-butylene sulfite); preferred cyclic hydrocarbyl sulfites include 1,3,2-dioxathiolane, 2-oxide (1,2-ethylene sulfite). The cyclic hydrocarbyl sulfite is preferably in an amount of about 0.5 wt % to about 5 wt %, more preferably about 1 wt % to about 4 wt %, relative to the total weight of the nonaqueous electrolyte solution.

In some embodiments, the electrochemical additive is a saturated cyclic hydrocarbyl sulfate containing two to about six carbon atoms, preferably two to about four carbon atoms, and has a 5-membered or 6-membered ring, preferably a 5-membered ring. One or more substituents can be present on the ring, such as methyl or ethyl groups, preferably one or more methyl groups, more preferably, no substituents are present on the ring. Suitable saturated cyclic hydrocarbyl sulfates include 1,3,2-dioxathiolane 2,2-dioxide (1,2-ethylene sulfate), 1,3,2-dioxathiane 2,2-dioxide (1,3-propylene sulfate), 4-methyl-1,3,2-dioxathiane 2,2-dioxide (1,3-butylene sulfate), and 5,5-dimethyl-1,3,2-dioxathiane 2,2-dioxide. The saturated cyclic hydrocarbyl sulfate is preferably in an amount of about 0.25 wt % to about 5 wt %, more preferably about 1 wt % to about 4 wt %, relative to the total weight of the nonaqueous electrolyte solution.

When the electrochemical additive is a cyclic dioxadithio polyoxide compound, the cyclic dioxadithio polyoxide compound contains two to about six carbon atoms, preferably two to about four carbon atoms, and has 6-membered, 7-membered, or 8-membered ring. Preferably, the cyclic dioxadithio polyoxide compound contains two to about four carbon atoms, and has 6-membered or 7-membered ring. One or more substituents can be present on the ring, such as methyl or ethyl groups, preferably one or more methyl groups, more preferably, no substituents are present on the ring. Suitable cyclic dioxadithio polyoxide compounds include 1,5,2,4-dioxadithiane 2,2,4,4-tetroxide, 1,5,2,4-dioxadithiepane 2,2,4,4-tetraoxide (cyclodisone), 3-methyl-1,5,2,4-dioxadithiepane, 2,2,4,4-tetraoxide, and 1,5,2,4-dioxadithiocane, 2,2,4,4-tetraoxide; 1,5,2,4-dioxadithiane 2,2,4,4-tetroxide is preferred. The cyclic dioxadithio polyoxide compound is preferably in an amount of about 0.5 wt % to about 5 wt %, more preferably about 1 wt % to about 4 wt %, relative to the total weight of the nonaqueous electrolyte solution.

The phrases “another lithium-containing salt” and “other lithium containing salt” indicate that there are at least two lithium salts used in the preparation of the electrolyte solution. When the electrochemical additive is another lithium-containing salt, it is preferably in an amount of about 0.5 wt % to about 5 wt % relative to the total weight of the nonaqueous electrolyte solution. Suitable lithium-containing salts include all of the lithium-containing salts listed above; lithium di(fluoro)(oxolato)borate and lithium bis(oxolato)borate are preferred.

Mixtures of any two or more of the foregoing electrochemical additives can be used, including different electrochemical additives of the same type and/or electrochemical additives of different types. When mixtures of electrochemical additives are used, the combined amount of the electrochemical additives is about 0.25 wt % to about 5 wt % relative to the total weight of the nonaqueous electrolyte solution. Mixtures of an unsaturated cyclic carbonate and a saturated cyclic hydrocarbyl sulfite or mixtures of a cyclic sultone, a tris(trihydrocarbylsilyl) phosphite, and a cyclic dioxadithio polyoxide compound are preferred.

In some embodiments when an electrochemical additive is used, it is preferably not used with other electrochemical additives.

Additional ingredients that are often included in electrolyte solutions for lithium batteries can also be present in the electrolyte solutions of the present invention. Such additional ingredients include nitrile compounds such as succinonitrile and perfluoralkyl nitriles, and silazane compounds such as hexamethyldisilazane. A preferred additional ingredient is a nitrile compound; succinonitrile is a preferred nitrile compound. Typically, the amount of an optional ingredient is in the range of about 1 wt % to about 5 wt %, preferably about 1 wt % to about 4 wt %, relative to the total weight of the nonaqueous electrolyte solution.

Another embodiment of this invention provides a process for producing a nonaqueous electrolyte solution for a lithium battery. The process comprises combining components comprising i) a liquid electrolyte medium; ii) a lithium-containing salt; and iii) at least one oxygen-containing brominated flame retardant selected from a brominated benzene and a brominated fluorobenzene. Optionally, the components further comprise iv) at least one electrochemical additive as described above. The oxygen-containing brominated flame retardant is present in the electrolyte solution in a flame retardant amount. The ingredients can be combined in any order, although it is preferable to add all of the components to the liquid electrolyte medium. Optional ingredients are also preferably added to the liquid electrolyte medium. Features of, and preferences for, the liquid electrolyte medium, lithium-containing salt, oxygen-containing brominated flame retardant(s), electrochemical additive(s), and amounts of each component, are as described above.

In some preferred embodiments, a nitrile compound and another lithium-containing salt are components of the electrolyte solution. Nitrile compounds and lithium-containing salts are as described above. Preferably, the nitrile compound is succinonitrile, and the other lithium-containing salt is preferably lithium di(fluoro)(oxalato)borate.

Still another embodiment of this invention provides a process for producing a nonaqueous electrolyte solution for a lithium battery. The process comprises combining components comprising i) a liquid electrolyte medium; ii) a lithium-containing salt; and iii) at least one oxygen-containing brominated flame retardant. Optionally, the components further comprise iv) at least one electrochemical additive as described above. The oxygen-containing brominated flame retardant is selected from the group consisting of 2,6-dimethoxy-1-(1,4,7,10-tetraoxaundecyl)-3,4,5-tribromobenzene, 4,5,6-tribromo-1,2,3-tri(2-methoxyethoxy)benzene, 2,4-dibromo-5-methoxy-1-(1,4,7,10-tetraoxaundecyl)benzene, 2,5-dibromo-4-ethoxy-1-(1,4,7,10-tetraoxaundecyl)benzene, 4,5-dibromo-2-ethoxy-1-(1,4,7,10-tetraoxaundecyl)benzene, 3,4,5-tribromo-1-ethoxy-2-(1,4,7,10-tetraoxaundecyl)-benzene, 2,4-dibromo-5-methoxy-1-[(2-ethoxy)ethoxy]benzene, 2,4-dibromo-1-[(2-ethoxy)ethoxy]benzene, 2,6-dibromo-1-[(2-ethoxy)ethoxy]benzene, 2,6-dibromo-4-fluoro-1-[(2-methoxy)ethoxy]-benzene, 2,6-dibromo-4-fluoroanisole, and 4-fluoro-2-bromoanisole. Preferences for the liquid electrolyte medium, lithium-containing salt, electrochemical additive(s), and amounts of each component, are as described above.

The nonaqueous electrolyte solutions of the present invention, which contain one or more brominated flame retardants, are typically used in nonaqueous lithium batteries comprising a positive electrode, a negative electrode, and the nonaqueous electrolyte solution. A nonaqueous lithium battery can be obtained by injecting a nonaqueous electrolyte solution between the negative electrode and the positive electrode optionally having a separator therebetween.

The molecules 2,6-dimethoxy-1-(1,4,7,10-tetraoxaundecyl)-3,4,5-tribromobenzene, 4,5,6-tribromo-1,2,3-tri(2-methoxyethoxy)benzene, 2,4-dibromo-5-methoxy-1-(1,4,7,10-tetraoxaundecyl)benzene, 2,5-dibromo-4-ethoxy-1-(1,4,7,10-tetraoxaundecyl)benzene, 4,5-dibromo-2-ethoxy-1-(1,4,7,10-tetraoxaundecyl)benzene, 2,4-dibromo-5-methoxy-1-[(2-ethoxy)ethoxy]benzene, 3,4,5-tribromo-1-ethoxy-2-(1,4,7,10-tetraoxaundecyl)-benzene, and 2,6-dibromo-4-fluoro-1-[(2-methoxy)ethoxy]benzene are new compositions of matter. Some of the molecules that are brominated to form flame retardants of this invention are also new compositions of matter, in particular 2-ethoxy-1-(1,4,7,10-tetraoxaundecyl)benzene and 4-ethoxy-1-(1,4,7,10-tetraoxaundecyl)benzene.

The following examples are presented for purposes of illustration, and are not intended to impose limitations on the scope of this invention.

In Example 1, a modified horizontal UL-94 test was performed. This modified horizontal UL-94 test is quite similar to known, published horizontal UL-94 tests. See in this regard, e.g., Otsuki, M. et al. “Flame-Retardant Additives for Lithium-Ion Batteries.” Lithium-Ion Batteries. Ed. M. Yoshio et al. New York, Springer, 2009, 275-289. The modified UL-94 test was as follows:
Wicks were cut from round fiberglass wick, and cut edges were made smooth, and then dust and particles were removed from the wick surface. The wicks were dried for 20 hours at 120° C. prior to testing. Wicks were 5±0.1 inch (12.7±0.25 cm) long.
Each specimen to be tested was prepared in a dry box in a 4 oz. (120 mL) glass jar, by combining the desired amount of flame retardant and, when present, electrochemical additive, with the desired amount of the electrolyte solution, e.g., 20 wt % of the brominated flame retardant and 80 wt % of the electrolyte solution were combined to form the electrolyte solution containing the flame retardant. Prior to combination with the flame retardant, the electrolyte solution contained 1.2 M LiPF₆ in ethylene carbonate/ethyl methyl carbonate (wt ratio 3:7), Each wick was soaked in the electrolyte solution for 30 minutes.
Each specimen was removed from the electrolyte solution and held over the electrolyte solution until no dripping occurred, and then placed in a 4 oz. (120 mL) glass jar; the cap was closed to prevent electrolyte solution from evaporating.
The burner was ignited and adjusted to produce a blue flame 20±1 mm high.
A specimen was removed from its 4 oz. (120 mL) glass jar, and the specimen was placed on a metal support fixture in a horizontal position, secured at one end of the wick.
If an exhaust fan was running, it was shut off for the test.
The flame was at an angle of 45±2 degrees to the horizontal wick. One way to accomplish this when the burner had a burner tube was to incline the central axis of the burner tube toward an end of the specimen at an angle of 45±2 degrees from the horizontal.
The flame was applied to the free end of the specimen for 30±1 seconds without changing its position; the burner was removed after 30±1 seconds, or as soon as the combustion front on the specimen reached the 1 inch (2.54 cm) mark.
If the specimen continued to burn after removal of the test flame, the time in seconds was recorded, for either the flame to extinguish or for the combustion front (flame) to travel from the 1 inch (2.54 cm) mark to the 4 inch (10.16 cm) mark.

A specimen was considered to be “not flammable” if the flame extinguished when the burner was removed. A specimen was considered to be “flame retardant” if the flame extinguished before reaching the 1 inch (2.54 cm) mark. A specimen was considered to be “self-extinguishing” if the flame went out before reaching the 4 inch (10.16 cm) mark.

Each modified horizontal UL-94 test result reported below is the average of three runs.

### EXAMPLE 1

Various nonaqueous electrolyte solutions containing different oxygen-containing brominated flame retardants, prepared as described above, were subjected to the modified UL-94 test described above. Results are summarized in Table 1 below; as noted above, the reported numbers are an average value from three runs.

TABLE 1

| | Flame retardant | Bromine | | Time to | |
|---|---|---|---|---|---|
| Flame retardant | wt % in soln. | wt % in soln. | Result | extinguish | |
| 4,5-dibromo-2-ethoxy-1-(1,4,7,10- | 30 | 10.8 | fail* | 76 | s |
| tetraoxaundecyl)benzene | | | | | |
| 4,5-dibromo-2-ethoxy-1-(1,4,7,10- | 35 | 12.7 | flame retardant | 37 | s |
| tetraoxaundecyl)benzene | | | | | |
| 2,4-dibromo-1-[(2- | 25 | 12.3 | fail* | 185 | s |
| ethoxy)ethoxy]benzene | | | | | |
| 2,4-dibromo-1-[(2- | 35 | 17.3 | flame retardant | 15 | s |
| ethoxy)ethoxy]benzene | | | | | |
| 2-bromo-4-fluoroanisole | 30 | 11.7 | flame retardant | 47 | s |

*Comparative run.

### EXAMPLE 2

Tests of some flame retardants in coin cells were also carried out. Coin cells were assembled using nonaqueous electrolyte solutions containing the desired amount of flame retardant. The coin cells were then subjected to electrochemical cycling of CCCV charging to 4.2 V at C/5, with a current cutoff of C/50 in the CV portion, and CC discharge at C/5 to 3.0 V.

One sample was a nonaqueous electrolyte solution without a flame retardant, and contained 1.2 M LiPF₆ in ethylene carbonatelethyl methyl carbonate (wt ratio 3:7). The rest of the samples contained the desired amount of flame retardant in the electrolyte solution. Results are summarized in Table 2 below; the error range in the Coulombir efficiencies is about ±0.5% to about +1.0%.

TABLE 2

| | | | | Coulombic | | Discharge specific | |
|---|---|---|---|---|---|---|---|
| | Flame | | | efficiency | | capacity, mAh/g | |
| | retardant | Bromine | | 1st | 10th | 1st | 10th |
| Chemical Name | in soln. | in soln. | | cycle | cycle | cycle | cycle |
| Electrolyte soln.¹ | 0 | 0 | | 82.8% | 99.9% | 149.8 | 152.5 |
| 2,4-dibromo-5-methoxy-1-(1,4,7,10- | 8 wt % | 3.0 | wt % | 43.3% | 84.8% | 130.9 | 89.7 |
| tetraoxaundecyl)benzene² | | | | | | | |
| 4,5-dibromo-2-ethoxy-1-(1,4,7,10- | 8 wt % | 2.9 | wt % | 76% | 98.9% | 150.0 | 138.4 |
| tetraoxaundecyl)benzene² | | | | | | | |
| 2,5-dibromo-4-ethoxy-1-(1,4,7,10- | 8 wt % | 2.9 | wt % | 77.5% | 99.0% | 144.8 | 134.5 |
| tetraoxaundecyl)benzene² | | | | | | | |
| 2,5-dibromo-4-ethoxy-1-(1,4,7,10- | 8 wt % | 2.9 | wt % | 80.4% | 99.0% | 148.5 | 149.3 |
| tetraoxaundecyl)benzene² + | | | | | | | |
| LiDFOB³ (2 wt %) + | | | | | | | |
| succinonitrile (1 wt %) | | | | | | | |
| 2,4-dibromo-1-[(2- | 8 wt % | 3.95 | wt % | 69.9% | 99.05% | 147.8 | 151.7 |
| ethoxy)ethoxy]benzene² | | | | | | | |
| 2-bromo-4-fluoroanisole² | 8 wt % | 3.1 | wt % | 63.0% | 96.7% | 143.7 | 146.9 |

¹Comparative run.
²Data is from single best-performing cell.
³LiDFOB is lithium di(fluoro)(oxalato)borate.

### EXAMPLE 3

A brominated flame retardant of this invention and a comparative molecule were each subjected to solubility testing in an electrolyte solution as described in Example 2, and using the method described above (stirring overnight). Results are summarized in Table 3 below.

TABLE 3

| Compound | Solubility |
|---|---|
| 2,5-dibromo-1,4-dimethoxybenzene¹ | less than 5 wt % |
| 2,5-dibromo-4-ethoxy-1-(1,4,7,10- | more than 35 wt % |
| tetraoxaundecyl)benzene | |

¹Comparative run.

### EXAMPLE 4

### Synthesis of 4-ethoxy-1-(1,4,7,10-tetraoxaundecyl)benzene and 2,5-dibromo-4-ethoxy-1-(1,4,7,10-tetraoxaundecyl)benzene

Under a nitrogen atmosphere, a slurry of sodium hydride (2.7 g, 0.11 mol, 1.5 eq) in anhydrous THF (250 mL) was prepared in a 500-mL Schlenk flask. The slurry was set up for magnetic stirring, chilled to 0° C., and 4-ethoxyphenol (10.0 g, 0.072 mol, 1 eq.) was added dropwise, under a stream of N₂. Bubbling was observed in the reaction mixture, which turned blue-green. After stirring for 1 hour, monomethyl-terminated 1,4,7,10-tetraoxaundecyl-mesylate (22.5 g, 0.093 mol, 1.3 eq.) was added dropwise, under a stream of N₂, during which addition the reaction mixture quickly changed color from blue-green to light brown. The reaction mixture was then heated to 60° C. and stirred for 16 hours. After cooling, the reaction mass was quenched via cautious addition to deionized water (1 L). The product was then extracted with CH₂Cl₂ (200 mL) and the organic layer was washed with an additional 1 L of deionized water. Rotary evaporation yielded 18.0 g of a pale yellow liquid (88% yield). The product was analyzed by ¹H-NMR, and determined to be 95% 4-ethoxy-1-(1,4,7,10-tetraoxaundecyl)benzene contaminated with 5% residual methyl-terminated 1,4,7,10-tetraoxaundecyl-mesylate; this product was used in the next step (preparation of the brominated compound).

A solution of a portion of the 4-ethoxy-1-(1,4,7,10-tetraoxaundecyl)benzene prepared above (10.35 g, 36.4 mmol, 1 eq) and iodine (0.26 g) in CH₂Cl₂ (500 g) was prepared. While stirring the solution, Br₂ (16.3 g, 160 mmol, 2.8 eq) was added via a peristaltic pump (Ismatec® model no. CP 78016-45) at a rate to maintain the temperature of the reaction mass below 5° C. (20-minute addition time). The solution was stirred for an additional 2 hours at 0° C., and then quenched via addition of aqueous Na₂SO₃. The phases were separated and the organic phase was condensed via rotary evaporation to give a pale yellow liquid (14.46 g; 90% yield of 2,5-dibromo-4-ethoxy-1-(1,4,7,10-tetraoxaundecyl)benzene), which was further purified via column chromatography (silica; eluent: 93:7 CH₂Cl₂/MeOH). ¹H-NMR (CDCl₃): δ7.16; (s, 1H); 7.08; (s, 1H); 4.12; (m 2H); 4.03; (q, 2H); 3.86; (t, 2H); 3.76; (m, 2H); 3.68-3.64; (m, 4H); 3.54; (m, 2H); 3.37; (s, 3H); 1.43; (t, 3H).

### EXAMPLE 5

### Synthesis of 2-ethoxy-1-(1,4,7,10-tetraoxaundecyl)benzene and 4,5-dibromo-2-ethoxy-1-(1,4,7,10-tetraoxaundecyl)benzene

Under N₂, a slurry of sodium hydride (2.2 g, 92.5 mmol, 1.2 eq) in anhydrous DMF (250 mL) was prepared in a 500-mL Schlenk flask. The slurry was set up for magnetic stirring, chilled to 0° C., and 2-ethoxyphenol (10.66 g, 77 mmol, 1 eq) was added dropwise; vigorous bubbling was observed (H₂ evolution). After stirring for 2 hours, methyl-terminated 1,4,7,10-tetraoxaundecyl-mesylate (22 g, 93 mmol, 1.2 eq) was added dropwise. The reaction mixture was then heated to 60° C. and stirred for 16 hours. After confirming by ¹H-NMR that the reaction was complete, the reaction mass was quenched by pouring it into 600 mL of H₂O. The product was then extracted into CH₂Cl₂ and the organic layer was washed with three 100 mL portions of 5% HCl, and then deionized water. Rotary evaporation of the organic phase yielded the product as a clear liquid, contaminated with residual DMF. Distillation at 100° C. under reduced pressure (2 mm Hg) yielded 19.6 g of 2-ethoxy-1-(1,4,7,10-tetraoxaundecyl)benzene as a pale yellow oil (90%).

A solution of 2-ethoxy-1-(1,4,7,10-tetraoxaundecyl)benzene (5.75 g, 20.2 mmol, 1 eq) and iodine (0.43 g) in CH₂Cl₂ (100 mL) was prepared. While stirring the solution, Br₂ (7.0 g, 160 mmol, 2.18 eq) was added via a peristaltic pump (Ismatec® model no. CP 78016-45) at a rate to maintain the temperature of the reaction mass below 13° C. (10-minute addition time). The solution was stirred for an additional 2 hours at 0° C., and overnight at ambient temperature. The pale yellow reaction mass was then quenched by addition of an aqueous solution of sodium sulfite. The phases were separated and the organic phase was condensed via rotary evaporation to give a pale yellow liquid (7.89 g; 88% yield of 4,5-dibromo-2-ethoxy-1-(1,4,7,10-tetraoxaundecyl)benzene). ¹H-NMR (CDCl₃): δ7.13; (s, 1H); 7.05; (s, 1H); 4.11; (m, 2H); 4.01; (m, 2H); 3.85; (m, 2H); 3.71; (m, 2H); 3.65; (m 4H); 3.53; (m, 2H); 3.36; (s, 3H); 1.14; (t, 3H). The product was contaminated with 20% phenol-containing impurities. The phenol-containing impurities were converted to propoxy groups by subjecting the crude product to alkylation conditions, in which crude 4,5-dibromo-2-ethoxy-1-(1,4,7,10-tetraoxaundecyl)benzene (6 g) was added dropwise to a slurry of NaH (0.210 g) in dry DMF (20 mL) at 0° C. under a constant stream of N₂. After stirring for 30 minutes, n-propyl bromide (1.1 g) was added. The reaction mixture was then refluxed at 60° C. for 5 hours, after which the reaction mass was allowed to cool and then quenched by cautious addition to water (500 mL). The organic product was separated and residual DMF was removed via short path distillation under reduced pressure (21 mm Hg) to yield a 4:1 mixture of 4,5-dibromo-2-ethoxy-1-(1,4,7,10-tetraoxaundecyl)benzene and 4,5-dibromo-2-propoxy-1-(1,4,7,10-tetraoxaundecyl)benzene.

### EXAMPLE 6

### Synthesis of 4,5-dibromo-2-ethoxyphenol

A solution of 2-ethoxyphenol (42.0 g, 0.304 mol) and iodine (50 mg) in methylene chloride (600 mL) was prepared. While stirring the solution, Br₂ (100 g, 0.625 mol) was added dropwise over the course of 1 hour, maintaining the temperature below 5° C. The reaction mixture was stirred for an additional 2 hours at 5° C., and then the excess bromine was quenched by addition of aqueous Na₂SO₃. which discolored the red solution. The phases were separated, and the organic phase was dried over anhydrous Na₂SO₄, and the methylene chloride was stripped from the dried organic phase via rotary evaporation to yield a white crystalline solid (86 g, 96% yield).

### EXAMPLE 7

### Synthesis of 2,3,4-tribromo-6-ethoxyphenol

A solution of 4,5-dibromo-2-ethoxyphenol (30.0 g, 0.101 mol) and iodine (46 mg) in methylene chloride (500 mL) was prepared. While stirring the solution, Br₂ (17.1 g, 0.106 mol) was added dropwise during 15 minutes, maintaining a temperature of 12° C. The reaction mixture was stirred at ambient temperature for an additional 2 weeks. The reaction mixture was treated with aqueous Na₂S₃ to quench any excess bromine. The phases were separated, and the organic phase was dried over anhydrous Na₂SO₄. A 94% conversion to the tribromo compound was obtained. The third bromine atom was determined to be ortho to the phenol hydroxyl group rather than ortho to the ethoxy group from the ¹H-NAIR spectrum.

¹H-NMR (CDCl₃): δ7.11; (s, 1H); 5.11; (s, 1H, O—H); 4.12; (q, 2H); 1.47; (t, 3H).

¹³C-NMR (CDCl₃): δ5.65; 144.04; 118.82; 115.41; 114.49; 112.23; 65.72; 14.78.

### EXAMPLE 8

### Synthesis of 3,4,5-tribromo-1-ethoxy-2-(1,4,7,10-tetraoxaundecyl)-benzene

A slurry containing 6-ethoxy-2,3,4-tribromophenol (1.25 g, 0.0033 mol), potassium carbonate (2.2 g, 0.016 mol), and methyl-terminated 1,4,7,10-tetraoxaundecyl-mesylate (1 g, 0.0041 mol), in acetone (25 mL) was prepared in a 250 mL round bottom flask. The slurry was stirred with a magnetic stirbar and heated under reflux at 65° C. for 42 hours. The acetone was then stripped from the mixture and the residue obtained was partitioned between dichloromethane (50 mL) and water (50 mL). The dichloromethane phase was concentrated by rotary evaporation and the residue therein was chromatographed on silica gel using dichloromethane as the eluent, yielding the product as a clear oil (0.9 g, 52% yield).

¹H-NMR (CDCl₃): 67.14; (s, 1H); 4.15; (t, 2H); 4.01; (q, 2H); 3.82; (t, 2H); 3.71; (m, 2H); 3.65-3.61; (m, 4H); 3.52; (m, 2H); 3.35; (s, 1H); 1.42; (t, 3H).

¹³C-NMR (CDCl₃): δ1.91; 146.54; 122.19; 119.36; 118.29; 117.26; 72.42; 72.01; 70.75; 70.74; 70.64; 70.39; 65.18; 59.10; 14.72.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A nonaqueous electrolyte solution for a lithium battery, which solution comprises
i) a liquid electrolyte medium;
ii) a lithium-containing salt; and
iii) at least one oxygen-containing brominated flame retardant selected from
A) a brominated benzene comprising one phenyl ring having two or three bromine atoms bound to the phenyl ring and at least one oxygen-containing group bound to the phenyl ring via an oxygen atom, any remaining sites on the phenyl ring each being bound to a hydrogen atom, with the proviso that when there is only one oxygen-containing group, the oxygen-containing group is an alkoxyether group, and
B) a brominated fluorobenzene comprising one phenyl ring having at least one bromine atom bound to the phenyl ring, at least one fluorine atom bound to the phenyl ring, and an oxygen-containing group bound to the phenyl ring via an oxygen atom, wherein the oxygen-containing group is an alkoxyether group or an alkoxy group.

2. A solution as in claim 1 wherein the oxygen-containing brominated flame retardant is
a brominated benzene which has about eight to about twenty carbon atoms, two to about ten oxygen atoms, and/or a bromine content of about 30 wt % or more relative to the total weight of the brominated flame retardant; or
a brominated fluorobenzene having one fluorine atom bound to the phenyl ring, one bromine atom or two bromine atoms bound to the phenyl ring, and/or a bromine content of about 35 wt % or more relative to the total weight of the brominated flame retardant.

3. A solution as in claim 1 wherein the oxygen-containing brominated flame retardant is
I) a brominated benzene which has two oxygen-containing groups on the phenyl ring, which oxygen-containing groups are the alkoxyether group and a hydrocarbyloxy group; or a brominated fluorobenzene in which a bromine atom is adjacent to the oxygen-containing group; or
II) a brominated benzene which has one oxygen-containing group bound to the phenyl ring; or a brominated fluorobenzene which has only one fluorine atom bound to the phenyl ring, and the fluorine atom is para relative to the oxygen-containing group.

4. (canceled)

5. A solution as in claim 1 wherein the brominated fluorobenzene is 2,6-dibromo-4-fluoro-1-[(2-methoxy)ethoxy]benzene, 2,6-dibromo-4-fluoro-1-methoxybenzene, 2,6-dibromo-4-fluoro-1-ethoxybenzene, 4-fluoro-2-bromo-1-methoxybenzene, or 4-fluoro-2-bromo-1-methoxybenzene.

6. A solution as in claim 3 wherein
in I) the oxygen-containing brominated flame retardant is a brominated benzene which is 2,4-dibromo-5-methoxy-1-(1,4,7,10-tetraoxaundecyl)benzene, 2,4-dibromo-5-ethoxy-1-(1,4,7,10-tetraoxaundecyl)benzene, 2,5-dibromo-4-methoxy-1-(1,4,7,10-tetraoxaundecyl)benzene, 2,5-dibromo-4-ethoxy-1-(1,4,7,10-tetraoxaundecyl)benzene, 4,5-dibromo-2-ethoxy-1-(1,4,7,10-tetraoxaundecyl)benzene, 3,4,5-tribromo-1-ethoxy-2-(1,4,7,10-tetraoxaundecyl)-benzene, 2,4-dibromo-5-methoxy-1-[(2-ethoxy)ethoxy]benzene, or 2,4-dibromo-5-ethoxy-1-[(2-ethoxy)ethoxy]benzene;
in II) the oxygen-containing brominated flame retardant is a brominated benzene which has at least one bromine atom adjacent to the oxygen-containing group.

7. (canceled)

8. A solution as in claim 6 wherein in II) the brominated benzene is 2,4-dibromo-1-[(2-ethoxy)ethoxy]benzene, 2,6-dibromo-1-[(2-ethoxy)ethoxy]benzene, or 2,6-dibromo-4-fluoro-1-[(2-methoxy)ethoxy]benzene.

9. A solution as in claim 1 wherein the oxygen-containing brominated flame retardant is a brominated benzene which has three bromine atoms on the phenyl ring, and which has three oxygen-containing groups on the phenyl ring, wherein i) one of the oxygen-containing groups is an alkoxyether group and the other two oxygen-containing groups are hydrocarbyloxy groups, or ii) all three oxygen-containing groups are alkoxyether groups.

10. A solution as in claim 9 wherein the brominated benzene is 2,6-dimethoxy-1-(1,4,7,10-tetraoxaundecyl)-3,4,5-tribromobenzene or 4,5,6-tribromo-1,2,3-tri(2-methoxyethoxy)benzene.

11. A solution as in claim 1 wherein the oxygen-containing brominated flame retardant is a brominated benzene, and wherein each alkoxyether group has two to about ten carbon atoms and two to about eight oxygen atoms.

12. A solution as in claim 1 wherein the oxygen-containing brominated flame retardant is a brominated benzene which is in an amount of about 12.5 wt % or more bromine relative to the total weight of the solution.

13. A solution as in claim 1 wherein the oxygen-containing brominated flame retardant is a brominated fluorobenzene which is in an amount of about 11.5 wt % or more bromine relative to the total weight of the solution.

14. A solution as in claim 1 wherein the liquid electrolyte medium is ethylene carbonate, ethyl methyl carbonate, or a mixture thereof, and/or wherein the lithium-containing salt is lithium hexafluorophosphate, lithium di(fluoro)(oxalato)borate, or lithium bis(oxalato)borate.

15. A solution as in claim 1 further comprising at least one electrochemical additive selected from:
a) unsaturated cyclic carbonates containing three to about six carbon atoms,
b) fluorine-containing saturated cyclic carbonates containing three to about five carbon atoms and one to about four fluorine atoms,
c) tris(trihydrocarbylsilyl) phosphites containing three to about nine carbon atoms,
d) trihydrocarbyl phosphates containing three to about twelve carbon atoms,
e) cyclic sultones containing three to about eight carbon atoms,
f) saturated cyclic hydrocarbyl sulfites having a 5-membered or 6-membered ring and containing two to about six carbon atoms,
g) saturated cyclic hydrocarbyl sulfates having a 5-membered or 6-membered ring and containing two to about six carbon atoms,
h) cyclic dioxadithio polyoxide compounds having a 6-membered, 7-membered, or 8-membered ring and containing two to about six carbon atoms,
i) another lithium-containing salt, and
j) mixtures of any two or more of the foregoing; or
II)
a) unsaturated cyclic carbonates containing three to about four carbon atoms,
b) fluorine-containing saturated cyclic carbonates containing three to about four carbon atoms and one to about two fluorine atoms,
c) tris(trihydrocarbylsilyl) phosphites containing three to about six carbon atoms,
d) trihydrocarbyl phosphates containing three to about nine carbon atoms,
e) cyclic sultones containing three to about four carbon atoms, saturated cyclic hydrocarbyl sulfites having a 5-membered ring and containing two to about four carbon atoms,
g) saturated cyclic hydrocarbyl sulfates having a 5-membered ring and containing two to about four carbon atoms,
h) cyclic dioxadithio polyoxide compounds having a 6-membered or 7-membered ring and containing two to about four carbon atoms,
i) another lithium-containing salt, and
j) mixtures of any two or more of the foregoing.

16. (canceled)

17. A solution as in claim 15 or 16 wherein the electrochemical additive is selected from:
a) an unsaturated cyclic carbonate in an amount of about 0.5 wt % to about 12 wt %, relative to the total weight of the nonaqueous electrolyte solution,
b) a fluorine-containing saturated cyclic carbonate in an amount of about 0.5 wt % to about 8 wt %, relative to the total weight of the nonaqueous electrolyte solution,
c) a tris(trihydrocarbylsilyl) phosphite in an amount of about 0.1 wt % to about 5 wt %, relative to the total weight of the nonaqueous electrolyte solution,
d) a trihydrocarbyl phosphate in an amount of about 0.5 wt % to about 5 wt %, relative to the total weight of the nonaqueous electrolyte solution,
e) a cyclic sultone in an amount of about 0.25 wt % to about 5 wt %, relative to the total weight of the nonaqueous electrolyte solution,
f) a saturated cyclic hydrocarbyl sulfite in an amount of about 0.5 wt % to about 5 wt %, relative to the total weight of the nonaqueous electrolyte solution,
g) a saturated cyclic hydrocarbyl sulfate in an amount of about 0.25 wt % to about 5 wt %, relative to the total weight of the nonaqueous electrolyte solution,
h) a cyclic dioxadithio polyoxide compound in an amount of about 0.5 wt % to about 5 wt %, relative to the total weight of the nonaqueous electrolyte solution,
i) another lithium-containing salt in an amount of about 0.5 wt % to about 5 wt %, relative to the total weight of the nonaqueous electrolyte solution, and
j) mixtures of any two or more of the foregoing.

18. A solution as in claim 15 wherein each electrochemical additive is not used with other electrochemical additives.

19. A solution as in claim 1 wherein the solution further comprises a nitrile compound, optionally wherein the nitrile compound is succinonitrile, or wherein the solution further comprises a nitrile compound and another lithium-containing salt, optionally wherein the nitrile compound is succinonitrile and the lithium-containing salt is lithium di(fluoro)(oxalato)borate.

20-22. (canceled)

23. A nonaqueous lithium battery comprising a positive electrode, a negative electrode, and a nonaqueous electrolyte solution as in claim 1.

24. A nonaqueous electrolyte solution for a lithium battery as in claim 1, in which the solution comprises
at least one oxygen-containing brominated flame retardant is selected from the group consisting of 2,6-dimethoxy-1-(1,4,7,10-tetraoxaundecyl)-3,4,5-tribromobenzene, 4,5,6-tribromo-1,2,3-tri(2-methoxyethoxy)benzene, 2,4-dibromo-5-methoxy-1-(1,4,7,10-tetraoxaundecyl)benzene, 2,4-dibromo-5-ethoxy-1-(1,4,7,10-tetraoxaundecyl)benzene, 2,5-dibromo-4-methoxy-1-(1,4,7,10-tetraoxaundecyl)benzene, 2,5-dibromo-4-ethoxy-1-(1,4,7,10-tetraoxaundecyl)benzene, 4,5-dibromo-2-ethoxy-1-(1,4,7,10-tetraoxaundecyl)benzene, 3,4,5-tribromo-2-(1,4,7,10-tetraoxaundecyl)-1-ethoxybenzene, 2,4-dibromo-5-methoxy-1-[(2-ethoxy)ethoxy]benzene, 2,4-dibromo-5-ethoxy-1-[(2-ethoxy)ethoxy]benzene, 2,4-dibromo-1-[(2-ethoxy)ethoxy]benzene, 2,6-dibromo-1-[(2-ethoxy)ethoxy]benzene, 2,6-dibromo-4-fluoro-1-[(2-methoxy)ethoxy]benzene, 2,6-dibromo-4-fluoro-1-methoxybenzene, 2,6-dibromo-4-fluoro-1-ethoxybenzene, 4-fluoro-2-bromo-1-methoxybenzene, and 4-fluoro-2-bromo-1-methoxybenzene.

25. A solution as in claim 24 wherein the oxygen-containing brominated flame retardant is in an amount of about 12 wt % or more bromine relative to the total weight of the solution.

26. A solution as in claim 24 wherein the liquid electrolyte medium is ethylene carbonate, ethyl methyl carbonate, or a mixture thereof, and/or wherein the lithium-containing salt is lithium hexafluorophosphate, lithium di(fluoro)(oxalato)borate, or lithium bis(oxalato)borate.

27. A solution as in claim 24 wherein the solution further comprises a nitrile compound, optionally wherein the nitrile compound is succinonitrile, or a nitrile compound and another lithium-containing salt, optionally wherein the nitrile compound is succinonitrile and the lithium-containing salt is lithium di(fluoro)(oxalato)borate.

28. (canceled)

29. A nonaqueous lithium battery comprising a positive electrode, a negative electrode, and a nonaqueous electrolyte solution as in claim 24.

30. A process for producing a nonaqueous electrolyte solution for a lithium battery, which process comprises combining components comprising:
i) a liquid electrolyte medium;
ii) a lithium-containing salt; and
iii) at least one oxygen-containing brominated flame retardant selected from
A) a brominated benzene comprising one phenyl ring having two or three bromine atoms bound to the phenyl ring and at least one oxygen-containing group bound to the phenyl ring via an oxygen atom, any remaining sites on the phenyl ring each being bound to a hydrogen atom, with the proviso that and when there is only one oxygen-containing group, the oxygen-containing group is an alkoxyether group, and
B) a brominated fluorobenzene comprising a phenyl ring having at least one bromine atom bound to the phenyl ring, at least one fluorine atom bound to the phenyl ring, and an oxygen-containing group bound to the phenyl ring via an oxygen atom, wherein the oxygen-containing group is an alkoxyether group or an alkoxy group.

31. A process as in claim 30 wherein the components further comprise at least one electrochemical additive selected from:
a) unsaturated cyclic carbonates containing three to about six carbon atoms,
b) fluorine-containing saturated cyclic carbonates containing three to about five carbon atoms and one to about four fluorine atoms,
c) tris(trihydrocarbylsilyl) phosphites containing three to about nine carbon atoms,
d) trihydrocarbyl phosphates containing three to about twelve carbon atoms,
e) cyclic sultones containing three to about eight carbon atoms,
f) saturated cyclic hydrocarbyl sulfites having a 5-membered or 6-membered ring and containing two to about six carbon atoms,
g) saturated cyclic hydrocarbyl sulfates having a 5-membered or 6-membered ring and containing two to about six carbon atoms,
h) cyclic dioxadithio polyoxide compounds having a 6-membered, 7-membered, or 8-membered ring and containing two to about six carbon atoms,
i) another lithium-containing salt, and
j) mixtures of any two or more of the foregoing.

32. A process as in claim 30 wherein the components further comprise a nitrile compound, optionally wherein the nitrile compound is succinonitrile, or a nitrile compound and another lithium-containing salt, optionally wherein the nitrile compound is succinonitrile and the lithium-containing salt is lithium di(fluoro)(oxalato)borate.

33. (canceled)

34. A process for producing a nonaqueous electrolyte solution for a lithium battery as in claim 30, in which
at least one oxygen-containing brominated flame retardant is selected from the group consisting of 2,6-dimethoxy-1-(1,4,7,10-tetraoxaundecyl)-3,4,5-tribromobenzene, 4,5,6-tribromo-1,2,3-tri(2-methoxyethoxy)benzene, 2,4-dibromo-5-methoxy-1-(1,4,7,10-tetraoxaundecyl)benzene, 2,4-dibromo-5-ethoxy-1-(1,4,7,10-tetraoxaundecyl)benzene, 2,5-dibromo-4-methoxy-1-(1,4,7,10-tetraoxaundecyl)benzene, 2,5-dibromo-4-ethoxy-1-(1,4,7,10-tetraoxaundecyl)benzene, 4,5-dibromo-2-ethoxy-1-(1,4,7,10-tetraoxaundecyl)benzene, 3,4,5-tribromo-1-ethoxy-2-(1,4,7,10-tetraoxaundecyl)-benzene, 2,4-dibromo-5-methoxy-1-[(2-ethoxy)ethoxy]benzene, 2,4-dibromo-5-ethoxy-1-[(2-ethoxy)ethoxy]benzene, 2,4-dibromo-1-[(2-ethoxy)ethoxy]benzene, 2,6-dibromo-1-[(2-ethoxy)ethoxy]benzene, 2,6-dibromo-4-fluoro-1-[(2-methoxy)ethoxy]benzene, 2,6-dibromo-4-fluoro-1-methoxybenzene, 2,6-dibromo-4-fluoro-1-ethoxybenzene, 4-fluoro-2-bromo-1-methoxybenzene, and 4-fluoro-2-bromo-1-methoxybenzene.

35. A process as in claim 34 wherein the components further comprise:
at least one electrochemical additive selected from vinylene carbonate, 4-fluoro-ethylene carbonate, tris(trimethylsilyl)phosphite, triallyl phosphate, 1,3-propane sultone, 1,3-propene sultone, ethylene sulfite, 1,3,2-dioxathiolane 2,2-dioxide, 1,5,2,4-dioxadithiane 2,2,4,4-tetroxide, lithium di(fluoro)(oxalato)borate, lithium bis(oxalato)borate, and mixtures of any two or more of these; and/or
a nitrile compound, optionally wherein the nitrile compound is succinonitrile, or wherein the components further comprise a nitrile compound and another lithium-containing salt, optionally wherein the nitrile compound is succinonitrile and the lithium-containing salt is lithium di(fluoro)(oxalato)borate.

36-38. (canceled)

39. Each of the following molecules separately, as a new composition of matter:
2,4-Dibromo-5-methoxy-1-(1,4,7,10-tetraoxaundecyl)benzene;
2,5-Dibromo-4-ethoxy-1-(1,4,7,10-tetraoxaundecyl)benzene;
4,5-Dibromo-2-ethoxy-1-(1,4,7,10-tetraoxaundecyl)benzene;
3,4,5-Tribromo-2-(1,4,7,10-tetraoxaundecyl)-1-ethoxybenzene;
2,4-Dibromo-5-methoxy-1-[(2-ethoxy)ethoxy]benzene;
2,6-Dibromo-4-fluoro-1-[(2-methoxy)ethoxy]benzene;
3,4,5-Tribromo-1-ethoxy-2-(1,4,7,10-tetraoxaundecyl)-benzene;
2-Ethoxy-1-(1,4,7,10-tetraoxaundecyl)benzene;
4-Ethoxy-1-(1,4,7,10-tetraoxaundecyl)benzene;
2,6-Dimethoxy-1-(1,4,7,10-tetraoxaundecyl)-3,4,5-tribromobenzene;
4,5,6-Tribromo-1,2,3-tri(2-methoxyethoxy)benzene.
